(19) United States
(12) Patent Application Publication
(10) Pub. No.: US 2008/0266235 A1
(43) Pub. Date: Oct. 30, 2008

(54) METHODS AND SYSTEMS FOR ADJUSTING BACKLIGHT LUMINANCE

(76) Inventors: Paul M. Hupman, Magnolia, TX (US); Barry N. Carroll, The Woodlands, TX (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/742,575

(22) Filed: Apr. 30, 2007

(51) Int. Cl. G09G 3/36

(52) U.S. Cl. 345/102

(57) ABSTRACT

A display system is provided, the display system having a processor and a Liquid Crystal Display (LCD) coupled to the processor. The display system also includes a backlight for the LCD panel, the backlight having an adjustable backlight luminance. The processor causes a plurality of successive image frames to be displayed on the LCD panel. The backlight luminance is selectively adjusted for each of the image frames.

### BACKGROUND

Many electronic devices have a Liquid Crystal Display (LCD) panel to display grayscale or color images. The color depth and contrast of an LCD panel are limited by the control range of the LCD electronics and the performance of the liquid crystal. Improvements to LCD color depth and contrast are continually being sought.

### BRIEF DESCRIPTION OF THE DRAWINGS

For a detailed description of exemplary embodiments of the invention, reference will now be made to the accompanying drawings in which:

FIG. 1 illustrates a system in accordance with embodiments;

FIG. 2 illustrates a computer in accordance with embodiments;

FIG. 3 shows a luminance level graph for a Liquid Crystal Display (LCD) panel in accordance with embodiments; and

FIG. 4 shows a method in accordance with embodiments.

### NOTATION AND NOMENCLATURE

Certain terms are used throughout the following description and claims to refer to particular system components. As one skilled in the art will appreciate, computer companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . .” Also, the term “couple” or “couples” is intended to mean either an indirect, direct, optical or wireless electrical connection. Thus, if a first device couples to a second device, that connection may be through a direct electrical connection, through an indirect electrical connection via other devices and connections, through an optical electrical connection, or through a wireless electrical connection.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

Embodiments enhance color depth and/or contrast of a Liquid Crystal Display (LCD) panel based on a dynamically-controlled backlight. In at least some embodiments, the backlight luminance level can be adjusted for successive frames displayed on the LCD panel. A Light Emitting Diode (LED) is an example of a backlight which reacts quickly enough to adjust the backlight luminance level for each successive frame. Other fast-responding backlights now known or later developed could alternatively be used.

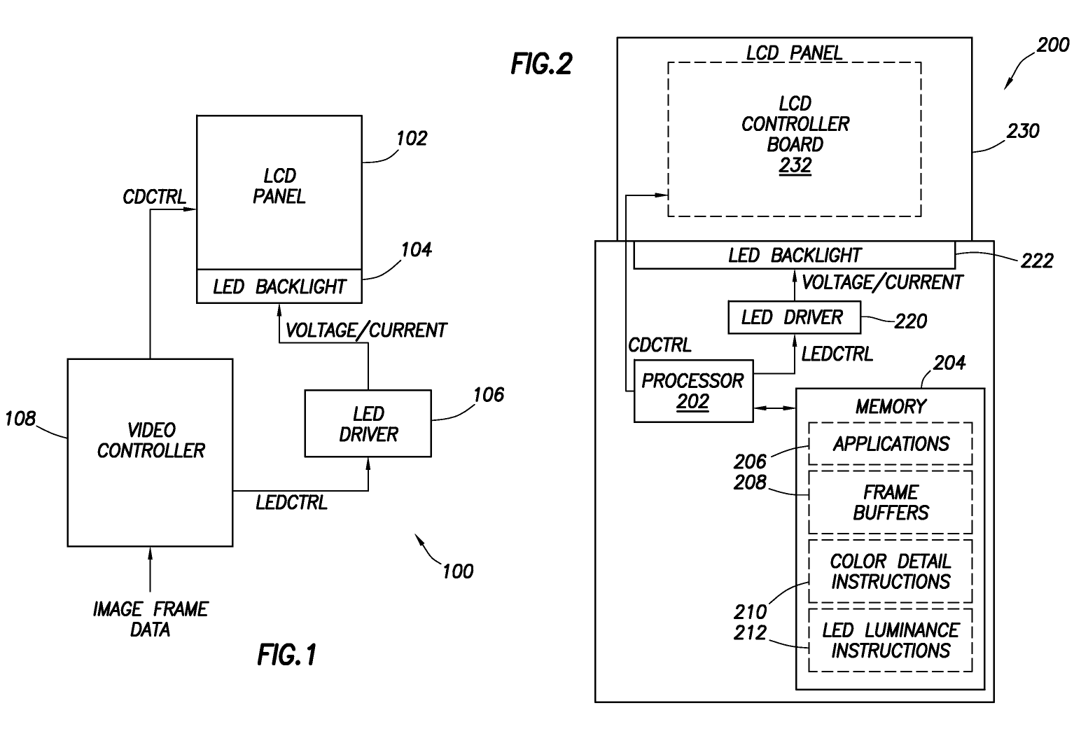

FIG. 1 illustrates a system 100 in accordance with embodiments. As shown, the system 100 comprises an LCD panel 102 with an LED backlight 104. The LED backlight 104 is controlled by an LED driver 106. As shown, a video controller 108 provides an LED luminance control signal (LEDCTRL) to the LED driver 106. In at least some embodiments, LEDCTRL is adjustable for each frame displayed on the LCD panel 102. As an example, the video controller 108 may receive and analyze image frame data to determine the luminance level of an image (or certain pixels of the image) to be displayed on the LCD panel 102. Once the video controller 108 has determined the luminance level of the image, LEDCTRL is output to the LED driver 106. In other words, LEDCTRL is a function of the luminance level of each image.

In some embodiments, the video controller 108 determines the luminance level of an image by analyzing the luminance value of each frame pixel and determining the minimum luminance value (MINLUM) of the frame pixels. The MINLUM of frame pixels may typically range between a first value (MINLUM_{low}) and a second value (MINLUM_{high}). After the MINLUM has been determined, the video controller 108 generates LEDCTRL for the LED driver 106. In at least some embodiments, LEDCTRL is a multi-bit (e.g., 8-bits) digital signal. As an example, if the MINLUM=MINLUM_{low}, then LEDCTRL could be 00000000 (minimum or no LED output). If the MINLUM=MINLUM_{high}, then LEDCTRL could be 11111111 (maximum LED output). If the MINLUM is between MINLUM_{low} and MINLUM_{high}, then LEDCTRL could be a corresponding value between 00000000 and 11111111.

In some embodiments, the video controller 108 determines the luminance level of an image by analyzing the luminance value of each frame pixel and determining the maximum luminance value (MAXLUM) of the frame pixels. The MAXLUM of frame pixels may typically range between a first value (MAXLUM_{low}) and a second value (MAXLUM_{high}). After the MAXLUM has been determined, the video controller 108 generates LEDCTRL for the LED driver 106. In at least some embodiments, LEDCTRL is a multi-bit (e.g., 8-bits) digital signal. As an example, if the MAXLUM=MAXLUM_{low}, then LEDCTRL could be 00000000 (minimum or no LED output). If the MAXLUM=MAXLUM_{high}, then LEDCTRL could be 11111111 (maximum LED output). If the MAXLUM is between MAXLUM_{low} and MAXLUM_{high}, then LEDCTRL could be a corresponding value between 00000000 and 11111111.

In some embodiments, the video controller 108 determines the luminance level of an image by analyzing the luminance value of each frame pixel and determining the average luminance value (AVGLUM) of the frame pixels. The AVGLUM of frame pixels may typically range between a first value (AVGLUM_{low}) and a second value (AVGLUM_{high}). After the AVGLUM has been determined, the video controller 108 generates LEDCTRL for the LED driver 106. In at least some embodiments, LEDCTRL is a multi-bit (e.g., 8-bits) digital signal. As an example, if the AVGLUM=AVGLUM_{low}, then LEDCTRL could be 00000000 (minimum or no LED output). If the AVGLUM=AVGLUM_{high}, then LEDCTRL could be 11111111 (maximum LED output). If the AVGLUM is between AVGLUM_{low} and AVGLUM_{high}, then LEDCTRL could be a corresponding value between 00000000 and 11111111. In at least some embodiments, LEDCTRL could be a function of the MINLUM, the MAXLUM and/or the AVGLUM for frame pixels of each image. Other factors could affect LEDCTRL as well (e.g., user input, different sets of high/low values for MINLUM, MAXLUM or AVGLUM). The process for determining the image luminance level can vary, for example, based on the LCD panel hardware that is implemented.

As shown, the video controller 108 also outputs a color detail luminance control signal (CDCTRL) to the LCD panel 102. In at least some embodiments, CDCTRL is a multi-bit signal (e.g., 24-bits) that controls the LCD light aperture of the LCD panel 102. By providing CDCTRL to the LCD panel 102 and LEDCTRL to the LED driver 106, the video controller 108 increases the perceived color depth of the LCD panel 102. As an example, if CDCTRL is a 24-bit signal and LEDCTRL is an 8-bit signal, the effective color depth of the LCD panel 102 is 32-bits.

FIG. 2 illustrates a computer 200 in accordance with embodiments. The computer 200 may be representative of a desktop computer, a laptop computer, or handheld devices having an LCD panel 230. As shown, the LCD panel 230 comprises an LCD controller board 232. In at least some embodiments, the LCD controller board 232 controls the LCD light aperture of the LCD panel 230 based on the CDCTRL signal described previously.

As shown, an LED backlight 222 is provided on at least one side of the LCD panel 230. The LED backlight 222 is powered by an LED driver 220 to provide light to the LCD panel 230. The LED driver 220 outputs distinct voltage levels or current levels to the LED backlight 222 based on the LEDCTRL signal discussed previously.

As shown, a processor 202 provides the CDCTRL signal to the LCD controller board 232 and provides the LEDCTRL signal to the LED driver 220. The processor 202 may be a video controller or another processor capable of generating appropriate CDCTRL and LEDCTRL signals. In alternative embodiments, the CDCTRL and LEDCTRL signals are provided by separate processors or video controllers.

In at least some embodiments, the processor 202 couples to a memory 204 which stores applications 206, frame buffers 208, color detail instructions 210 and LED luminance instructions 212. In at least some embodiments, the applications 206 include an operating system, a multimedia application, or other applications which are executable by the processor 202. When executed, the applications 206 cause images to be displayed on the LCD panel 230.

In at least some embodiments, the frame buffers 208 receive images from a source such as the applications 206. The images in the frame buffers 208 are periodically accessed and sent by the processor 202 to the LCD panel 230 for display. The images stored in the frame buffers 208 are represented using a color value and/or a luminance value for each pixel of the image.

In at least some embodiments, the color detail instructions 210 cause the processor 202 to examine images stored in the frame buffers 208 and to output the CDCTRL signal to the LCD controller board 232 which controls the LCD light aperture. As an example, the processor 202 may examine the color value for each pixel of an image and output a CDCTRL signal to control the LCD light aperture accordingly. In some embodiments, the color detail instructions 210 enable the processor 202 to increase or decrease the resolution (the number of bits used to represent the signal) of the CDCTRL signal. For example, the resolution of the CDCTRL signal could be adapted based on the resolution of the color values stored in the frame buffers 208 or the resolution of the LCD panel 230. Alternatively, the color detail instructions 210 could enable the processor 202 to maintain a fixed resolution for the CDCTRL value even if the color value resolution of pixels stored in the frame buffers 208 is higher or lower (e.g., different applications could generate different color value resolutions). Additionally, the color detail instructions 210 could enable the processor 202 to output different resolution CDCTRL signals based on the capabilities of the LCD panel 230 that is being used with the computer 200.

In at least some embodiments, the LED luminance instructions 212 cause the processor 202 to examine images stored in the frame buffers 208 and to output the LEDCTRL signal to the LED driver 220. As an example, the processor 202 may examine the luminance value for each pixel of an image and output a LEDCTRL signal to control the LED luminance level accordingly. As previously described, the LEDCTRL signal could be based on MINLUM, MAXLUM and/or AVGLUM calculations for each image frame. Other factors could affect LEDCTRL as well (e.g., user input, different sets of high/low values for MINLUM, MAXLUM or AVGLUM). If the processor 202 updates the CDCTRL and LEDCTRL signals for each frame displayed on the LCD panel 230, the perceived color depth and/or contrast of the LCD panel 230 is increased.

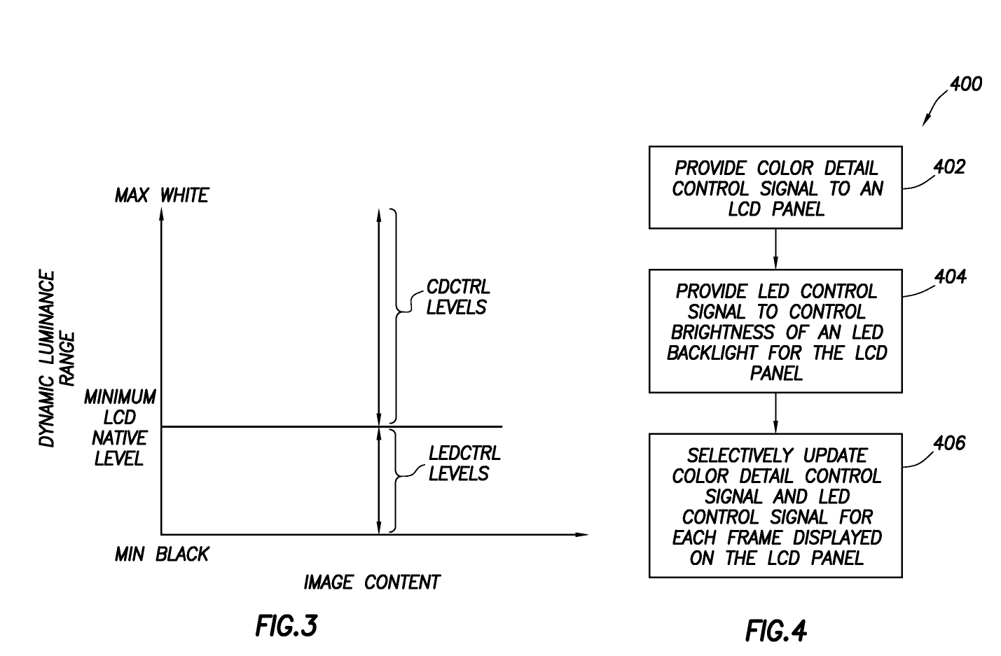

FIG. 3 shows a luminance level graph for a Liquid Crystal Display (LCD) panel in accordance with embodiments. As shown, the dynamic luminance range for image content on an LCD panel ranges between a minimum black level and a maximum white level. The number of levels that make up the dynamic luminance range is a combination of CDCTRL levels and LEDCTRL levels.

As shown in FIG. 3, there may be a minimum LCD native level of luminance that corresponds to the lowest level of LCD luminance that can be achieved if the CDCTRL level is at a minimum and the LEDCTRL level is at a maximum. In other words, if LED luminance is maximized and the LCD light apertures are minimized, the LCD panel will have some luminance referred to as the minimum LCD native level of luminance. To achieve greater contrast and color depth for an LCD panel, both the CDCTRL and LEDCTRL signals can be adjusted for each frame. The resolution (the number of possible levels) of the dynamic luminance range varies based on the number of control levels provided by CDCTRL and LEDCTRL.

FIG. 4 illustrates a method 400 in accordance with embodiments. As shown, the method 400 comprises providing a color detail control signal to an LCD panel (block 402). In at least some embodiments, the color detail control signal controls the LCD light aperture of the LCD panel and corresponds to the CDCTRL signal discussed previously. At block 404, an LED control signal is provided to control luminance of an LED backlight for the LCD panel. In at least some embodiments, the LED control signal corresponds to the LEDCTRL signal discussed previously and can be updated for each frame displayed on an LCD panel. At block 406, the color detail control signal and the LED control signals are selectively updated for each frame displayed by the LCD panel.

What is claimed is:

1. A display system, comprising:
a processor;
a Liquid Crystal Display (LCD) panel coupled to the processor; and
a backlight for the LCD panel, the backlight having an adjustable backlight luminance,
wherein the processor causes a plurality of successive image frames to be displayed on the LCD panel and wherein the backlight luminance is selectively adjusted for each of the image frames.

2. The display system of claim 1 wherein luminance of the LCD panel is based on a color detail control signal and a backlight control signal associated with each of the image frames.

3. The display system of claim 2 wherein color detail control signal is a multi-bit digital signal.

4. The display system of claim 2 wherein backlight control signal is a multi-bit digital signal.

5. The display system of claim 1 wherein the backlight comprises a light-emitting diode (LED).

6. The display system of claim 1 wherein the processor comprises a video controller that receives image data and that selectively adjusts the backlight luminance based on information extracted from the image data.

7. The display system of claim 1 further comprising a system memory coupled to the processor, the system memory comprises at least one frame buffer to store each of the image frames before each image frame is displayed on the LCD panel, wherein the backlight luminance is selectively adjusted based on information extracted from the at least one frame buffer.

8. The display system of claim 1 further comprising a system memory coupled to the processor, the system memory comprises color detail instructions that, when executed, cause the processor to examine pixel color values of each image frame and to control a light aperture of the LCD panel based on the pixel color values.

9. The display system of claim 1 further comprising a system memory coupled to the processor, the system memory comprises backlight control instructions that, when executed, cause the processor to examine pixel luminance values of each image frame and to output a backlight control signal to adjust the backlight luminance based on the pixel luminance values.

10. The display system of claim 9 wherein the backlight control signal is based on at least one of a minimum pixel luminance value determined for each image frame, a maximum pixel luminance value determined for each frame, and an average pixel value determined for each frame.

11. A method, comprising:
providing successive image frames to be displayed on a Liquid Crystal Display (LCD) panel; and
selectively adjusting a backlight luminance of the LCD panel for each of the image frames.

12. The method of claim 11 further comprising extracting information from each image frame to determine the backlight luminance.

13. The method of claim 11 further comprising analyzing pixel luminance values for each image frame and adjusting the backlight luminance based on the pixel luminance values.

14. The method of claim 11 further comprising analyzing pixel luminance values for each image frame and adjusting the backlight luminance based on a minimum pixel luminance value.

15. The method of claim 11 further comprising generating a multi-bit digital signal to control the backlight luminance based on at least one of a minimum pixel luminance value of each image frame, a maximum pixel luminance value of each image frame and an average pixel luminance value of each image frame.

16. The method of claim 11 further comprising controlling a color depth of the LCD panel for each frame based on a color detail control signal and a backlight control signal.

17. The method of claim 16 further comprising selectively changing a number of bits used to control the color depth.

18. The method of claim 11 wherein selectively adjusting a backlight luminance of the LCD panel for each of the image frames comprises adjusting luminance of a light-emitting diode (LED).

19. A computer-readable medium storing instructions executable by a processor, the instructions cause the processor to:
analyze successive image frames to be displayed on a Liquid Crystal Display (LCD) panel; and
selectively adjust a backlight luminance of the LCD panel for each of the image frames.

20. The computer-readable medium of claim 19 wherein the instructions further cause the processor to analyze pixel luminance values for each image frame and adjust the backlight luminance based on the pixel luminance values.

21. The computer-readable medium of claim 19 wherein the instructions further cause the processor to control color depth for each image frame by providing a color detail control signal and a backlight control signal.
